(19) United States
(12) Patent Application Publication
(10) Pub. No.: US 2025/0212229 A1
(43) Pub. Date: Jun. 26, 2025

(54) METHOD AND DEVICE FOR TRANSMITTING/RECEIVING SIGNAL IN WIRELESS COMMUNICATION SYSTEM

(71) Applicant: LG ELECTRONICS INC., Seoul (KR)

(72) Inventors: Seunghwan CHOI, Seoul (KR); Suckchel YANG, Seoul (KR); Seonwook KIM, Seoul (KR); Youngdae LEE, Seoul (KR)

(73) Assignee: LG ELECTRONICS INC., Seoul (KR)

(21) Appl. No.: 18/850,321

(22) PCT Filed: Apr. 28, 2023
(86) PCT No.: PCT/KR2023/005874

§ 371 Date: Sep. 24, 2024

Related U.S. Application Data
(60) Provisional application No. 63/336,269, filed on Apr. 28, 2022.

(30) Foreign Application Priority Data
Aug. 11, 2022 (KR) 10-2022-0100915
Feb. 16, 2023 (KR) 10-2023-0021062

(51) Int. Cl. H04W 72/232; H04L 1/1812; H04L 1/1867; H04W 72/1263

(52) U.S. Cl. CPC H04W 72/232; H04L 1/1812; H04L 1/1896; H04W 72/1263

(57) ABSTRACT

A method and a device for transmitting/receiving a signal in a wireless communication system, disclosed in the present specification, comprises receiving DCI for scheduling PDSCHs or PUSCHs on mutually different cells. Specifically, the DCI includes a NDI field, a RV field and/or a HPN field for the PDSCHs or PUSCHs on the mutually different cells.

### CROSS-REFERENCE TO RELATED APPLICATIONS

This application is the National Stage filing under 35 U.S.C. 371 of International Application No. PCT/KR2023/005874, filed on Apr. 28, 2023, which claims the benefit of earlier filing date and right of priority to Korean Application Nos. 10-2022-0100915, filed on Aug. 11, 2022, and 10-2023-0021062, filed on Feb. 16, 2023, and also claims the benefit of U.S. Provisional Application No. 63/336,269, filed on Apr. 28, 2022, the contents of which are all hereby incorporated by reference herein in their entireties.

### TECHNICAL FIELD

The present disclosure relates to a method and apparatus for use in a wireless communication system.

### BACKGROUND

Generally, a wireless communication system is developing to diversely cover a wide range to provide such a communication service as an audio communication service, a data communication service and the like. The wireless communication is a sort of a multiple access system capable of supporting communications with multiple users by sharing available system resources (e.g., bandwidth, transmit power, etc.). For example, the multiple access system may include one of code division multiple access (CDMA) system, frequency division multiple access (FDMA) system, time division multiple access (TDMA) system, orthogonal frequency division multiple access (OFDMA) system, single carrier frequency division multiple access (SC-FDMA) system, and the like.

### SUMMARY

The object of the present disclosure is to provide a signal transmission and reception method for efficiently transmitting and receiving control and data signals in a wireless communication system and apparatus therefor.

It will be appreciated by persons skilled in the art that the objects that could be achieved with the present disclosure are not limited to what has been particularly described hereinabove and the above and other objects that the present disclosure could achieve will be more clearly understood from the following detailed description.

The present disclosure provides a method and apparatus for transmitting and receiving a signal in a wireless communication system.

According to an aspect of the present disclosure, a method of transmitting and receiving a signal by a user equipment (UE) in a wireless communication system includes receiving downlink control information (DCI) for scheduling physical downlink shared channels (PDSCHs) or physical uplink shared channels (PUSCHs) on different cells, and receiving the PDSCHs on the different cells or transmitting the PUSCHs on the different cells based on the DCI, wherein the DCI includes a number of redundancy version (RV) fields, equal to a number of the PDSCHs or a number of the PUSCHs, and the DCI includes a number of hybrid automatic repeat and request acknowledgement process number (HPN) fields, equal to the number of the PDSCHs or the number of the PUSCHs.

According to another aspect of the present disclosure, a method of transmitting and receiving a signal by a base station (BS) in a wireless communication system includes transmitting downlink control information (DCI) for scheduling physical downlink shared channels (PDSCHs) or physical uplink shared channels (PUSCHs) on different cells, and transmitting the PDSCHs on the different cells or receiving the PUSCHs on the different cells based on the DCI, wherein the DCI includes a number of redundancy version (RV) fields, equal to a number of transport blocks (TBs) of the PDSCHs or a number of TBs of the PUSCHs, and the DCI includes a number of hybrid automatic repeat and request acknowledgement process number (HPN) fields, equal to a number of the PDSCHs or a number of the PUSCHs.

In another aspect of the present disclosure, there are provided an apparatus, a processor, and a storage medium for performing the signal transmission and reception method.

The apparatus may include an autonomous driving vehicle communicable with at least a UE, a network, and another autonomous driving vehicle other than the communication apparatus.

The above-described aspects of the present disclosure are only some of the preferred embodiments of the present disclosure, and various embodiments reflecting the technical features of the present disclosure may be derived and understood from the following detailed description of the present disclosure by those skilled in the art.

According to one embodiment of the present disclosure, when control and data signals are transmitted and received between communication devices, the signals may be transmitted and received more efficiently based on operations different from those in the prior art

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

FIG. 1 illustrates a radio frame structure.

FIG. 2 illustrates a resource grid during the duration of a slot.

FIG. 3 illustrates a self-contained slot structure.

FIG. 4 illustrates an acknowledgment/negative acknowledgment (ACK/NACK) transmission process.

FIG. 5 illustrates a physical uplink shared channel (PUSCH) transmission process.

FIGS. 6 to 7 are diagrams illustrating uplink (UL) channel transmission according to the embodiments of the present disclosure.

FIGS. 8 to 11 illustrate devices according to an embodiment of the present disclosure.

### DETAILED DESCRIPTION

The following technology may be used in various wireless access systems such as code division multiple access (CDMA), frequency division multiple access (FDMA), time division multiple access (TDMA), orthogonal frequency division multiple access (OFDMA), single carrier frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/enhanced data rates for GSM evolution (EDGE). OFDMA may be implemented as a radio technology such as institute of electrical and electronics engineers (IEEE) 802.11 (wireless fidelity (Wi-Fi)), IEEE 802.16 (worldwide interoperability for microwave access (WiMAX)), IEEE 802.20, evolved UTRA (E-UTRA), and so on. UTRA is a part of universal mobile telecommunications system (UMTS). 3rd generation partnership project (3GPP) long term evolution (LTE) is a part of evolved UMTS (E-UMTS) using E-UTRA, and LTE-advanced (LTE-A) is an evolution of 3GPP LTE. 3GPP new radio or new radio access technology (NR) is an evolved version of 3GPP LTE/LTE-A.

For clarity of description, the present disclosure will be described in the context of a 3GPP communication system (e.g., LTE and NR), which should not be construed as limiting the spirit of the present disclosure. LTE refers to a technology beyond 3GPP TS 36.xxx Release 8. Specifically, the LTE technology beyond 3GPP TS 36.xxx Release 10 is called LTE-A, and the LTE technology beyond 3GPP TS 36.xxx Release 13 is called LTE-A pro. 3GPP NR is the technology beyond 3GPP TS 38.xxx Release 15. LTE/NR may be referred to as a 3GPP system. “xxx” specifies a technical specification number. LTE/NR may be generically referred to as a 3GPP system. For the background technology, terminologies, abbreviations, and so on as used herein, refer to technical specifications published before the present disclosure. For example, the following documents may be referred to.

### 3GPP NR

38.211: Physical channels and modulation
38.212: Multiplexing and channel coding
38.213: Physical layer procedures for control
38.214: Physical layer procedures for data
38.300: NR and NG-RAN Overall Description
38.331: Radio Resource Control (RRC) protocol specification

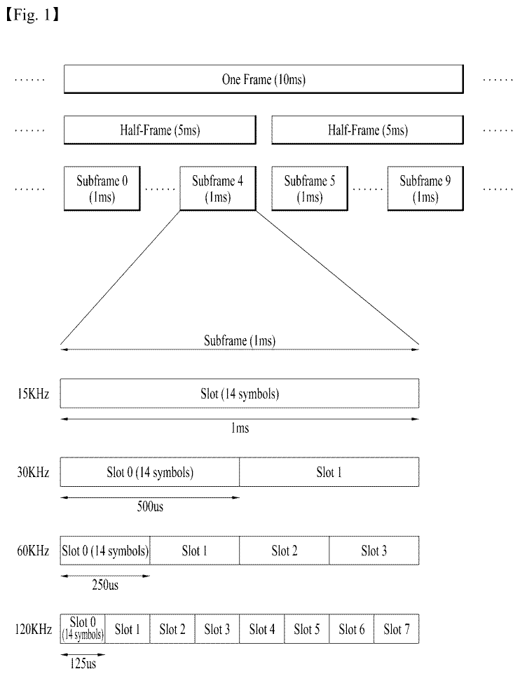

FIG. 1 illustrates a radio frame structure used for NR.

In NR, UL and DL transmissions are configured in frames. Each radio frame has a length of 10 ms and is divided into two 5-ms half-frames. Each half-frame is divided into five 1-ms subframes. A subframe is divided into one or more slots, and the number of slots in a subframe depends on a subcarrier spacing (SCS). Each slot includes 12 or 14 OFDM (A) symbols according to a cyclic prefix (CP). When a normal CP is used, each slot includes 14 OFDM symbols. When an extended CP is used, each slot includes 12 OFDM symbols. A symbol may include an OFDM symbol (or a CP-OFDM symbol) and an SC-FDMA symbol (or a discrete Fourier transform-spread-OFDM (DFT-s-OFDM) symbol).

Table 1 exemplarily illustrates that the number of symbols per slot, the number of slots per frame, and the number of slots per subframe vary according to SCSs in a normal CP case.

TABLE 1

| SCS (15*2\hat{ }u) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

*N^{slot}_{symb}: number of symbols in a slot
*N^{frame, u}ₛₗₒₜ: number of slots in a frame
*N^{subframe, u}ₛₗₒₜ: number of slots in a subframe

Table 2 illustrates that the number of symbols per slot, the number of slots per frame, and the number of slots per subframe vary according to SCSs in an extended CP case.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 KHz (u = 2) | 12 | 40 | 40 |

In the NR system, different OFDM (A) numerologies (e.g., SCSs, CP lengths, and so on) may be configured for a plurality of cells aggregated for one UE. Accordingly, the (absolute time) duration of a time resource (e.g., a subframe, a slot, or a transmission time interval (TTI)) (for convenience, referred to as a time unit (TU)) composed of the same number of symbols may be configured differently between the aggregated cells.

In NR, various numerologies (or SCSs) may be supported to support various 5th generation (5G) services. For example, with an SCS of 15 kHz, a wide area in traditional cellular bands may be supported, while with an SCS of 30 kHz or 60 kHz, a dense urban area, a lower latency, and a wide carrier bandwidth may be supported. With an SCS of 60 kHz or higher, a bandwidth larger than 24.25 kHz may be supported to overcome phase noise.

An NR frequency band may be defined by two types of frequency ranges, FR1 and FR2. FR1 and FR2 may be configured as described in Table 3 below. FR2 may be millimeter wave (mmW).

TABLE 3

| Frequency Range | Corresponding frequency | | |
|---|---|---|---|
| designation | range | Subcarrier Spacing | |
| FR1 | 450 MHz-7125 MHz | 15, 30, 60 | kHz |
| FR2 | 24250 MHz-52600 MHz | 60, 120, 240 | kHz |

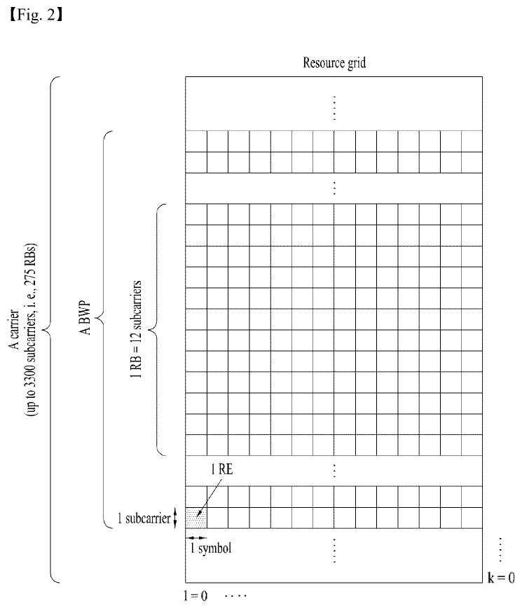

FIG. 2 illustrates a resource grid during the duration of one slot.

A slot includes a plurality of symbols in the time domain. For example, one slot includes 14 symbols in a normal CP case and 12 symbols in an extended CP case. A carrier includes a plurality of subcarriers in the frequency domain. A resource block (RB) may be defined by a plurality of (e.g., 12) consecutive subcarriers in the frequency domain. A plurality of RB interlaces (simply, interlaces) may be defined in the frequency domain. Interlace m∈{0, 1, . . . , M−1} may be composed of (common) RBs {m, M+m, 2M+m, 3M+m, . . . }. M denotes the number of interlaces. A bandwidth part (BWP) may be defined by a plurality of consecutive (physical) RBs ((P)RBs) in the frequency domain and correspond to one numerology (e.g., SCS, CP length, and so on). A carrier may include up to N (e.g., 5) BWPs. Data communication may be conducted in an active BWP, and only one BWP may be activated for one UE. Each element in a resource grid may be referred to as a resource element (RE), to which one complex symbol may be mapped.

In a wireless communication system, a UE receives information from a BS in downlink (DL), and the UE transmits information to the BS in uplink (UL). The information exchanged between the BS and UE includes data and various control information, and various physical channels/signals are present depending on the type/usage of the information exchanged therebetween. A physical channel corresponds to a set of resource elements (REs) carrying information originating from higher layers. A physical signal corresponds to a set of REs used by physical layers but does not carry information originating from the higher layers. The higher layers include a medium access control (MAC) layer, a radio link control (RLC) layer, a packet data convergence protocol (PDCP) layer, a radio resource control (RRC) layer, and so on.

DL physical channels include a physical broadcast channel (PBCH), a physical downlink shared channel (PDSCH), and a physical downlink control channel (PDCCH). DL physical signals include a DL reference signal (RS), a primary synchronization signal (PSS), and a secondary synchronization signal (SSS). The DL RS includes a demodulation reference signal (DM-RS), a phase tracking reference signal (PT-RS), and a channel state information reference signal (CSI-RS). UL physical channel include a physical random access channel (PRACH), a physical uplink shared channel (PUSCH), and a physical uplink control channel (PUCCH). UL physical signals include a UL RS. The UL RS includes a DM-RS, a PT-RS, and a sounding reference signal (SRS).

FIG. 3 illustrates a structure of a self-contained slot.

In the NR system, a frame has a self-contained structure in which a DL control channel, DL or UL data, a UL control channel, and the like may all be contained in one slot. For example, the first N symbols (hereinafter, DL control region) in the slot may be used to transmit a DL control channel, and the last M symbols (hereinafter, UL control region) in the slot may be used to transmit a UL control channel. N and M are integers greater than or equal to 0). A resource region (hereinafter, a data region) that is between the DL control region and the UL control region may be used for DL data transmission or UL data transmission. For example, the following configuration may be considered. Respective sections are listed in a temporal order.

In the present disclosure, a base station (BS) may be, for example, a gNode B (gNB).

### DL Physical Channel/Signal

### (1) PDSCH

A PDSCH carries DL data (e.g., DL-shared channel transport block (DL-SCH TB)). The TB is coded into a codeword (CW) and then transmitted after scrambling and modulation processes. The CW includes one or more code blocks (CBs). One or more CBs may be grouped into one code block group (CBG). Depending on the configuration of a cell, the PDSCH may carry up to two CWs. Scrambling and modulation may be performed for each CW, and modulation symbols generated from each CW may be mapped to one or more layers. Each layer may be mapped to resources together with a DMRS after precoding and transmitted on a corresponding antenna port. The PDSCH may be dynamically scheduled by a PDCCH (dynamic scheduling). Alternatively, the PDSCH may be semi-statically scheduled based on higher layer (e.g., RRC) signaling (and/or Layer 1 (L1) signaling (e.g., PDCCH)) (configured scheduling (CS)). Therefore, in the dynamic scheduling. PDSCH transmission is accompanied by the PDCCH, whereas in the CS, PDSCH transmission may not be accompanied by the PDCCH. The CS may include semi-persistent scheduling (SPS).

### (2) PDCCH

A PDCCH carries Downlink Control Information (DCI). For example, the PDCCH (i.e., DCI) may carry: transmission formats and resource allocation of a DL-SCH: frequency/time resource allocation information on an uplink shared channel (UL-SCH); paging information on a paging channel (PCH); system information on a DL-SCH; time/frequency resource allocation information on a higher layer control message such as a random access response (RAR) transmitted over a PDSCH; transmit power control commands; and information on activation/deactivation of SPS/CS. Various DCI formats may be provided depending on information in DCI.

Table 4 shows DCI formats transmitted over the PDCCH.

TABLE 4

| DCI | |
|---|---|
| format | Usage |
| 0_0 | Scheduling of PUSCH in one cell |
| 0_1 | Scheduling of one or multiple PUSCH in one cell, or |
| | indicating downlink feedback information for |
| | configured grant PUSCH (CG-DFI) |
| 1_0 | Scheduling of PDSCH in one cell |
| 1_1 | Scheduling of PDSCH in one cell, and/or triggering one |
| | shot HARQ-ACK codebook feedback |
| 2_0 | Notifying a group of UEs of the slot format, available RB |
| | sets, COT duration and search space set group switching |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS |
| | transmissions by one or more UEs |

DCI format 00 may be used to schedule a TB-based (or TB-level) PUSCH, and DCI format 0_1 may be used to schedule a TB-based (or TB-level) PUSCH or a CBG-based (or CBG-level) PUSCH. DCI format 10 may be used to schedule a TB-based (or TB-level) PDSCH, and DCI format 1_1 may be used to schedule a TB-based (or TB-level) PDSCH or a CBG-based (or CBG-level) PDSCH (DL grant DCI). DCI format 0_0/0_1 may be referred to as UL grant DCI or UL scheduling information, and DCI format 1_0/1_1 may be referred to as DL grant DCI or UL scheduling information. DCI format 20 may be used to provide dynamic slot format information (e.g., dynamic SFI) to the UE, and DCI format 2_1 may be used to provide downlink pre-emption information to the UE. UEs defined as one group may be provided with DCI format 2_0 and/or DCI format 2_1 over a group common PDCCH, which is a PDCCH defined for a group of UEs.

The PDCCH/DCI may include a cyclic redundancy check (CRC), and the CRC may be masked/scrambled with various identifiers (e.g., radio network temporary identifier (RNTI)) according to the owner or purpose of the PDCCH. For example, if the PDCCH is for a specific UE, the CRC may be masked with a cell-RNTI (C-RNTI). If the PDCCH relates to paging, the CRC may be masked with a paging-RNTI (P-RNTI). If the PDCCH relates to system information (e.g., system information block (SIB)), the CRC may be masked with a system information RNTI (SI-RNTI). If the PDCCH relates to a random access response, the CRC may be masked with a random access-RNTI (RA-RNTI).

Table 5 shows the usage of the PDCCH and transport channels according to the type of RNTI. Here, the transport channel means a transport channel related to data carried by a PDSCH/PUSCH scheduled by the PDCCH.

TABLE 5

| RNTI | Usage | Transport Channel |
|---|---|---|
| P-RNTI | Paging and System Information change notification | PCH(Paging Channel) |
| SI-RNTI | Broadcast of System Information | DL-SCH |
| RA-RNTI | Random Access Response | DL-SCH |
| Temporary C-RNTI | Contention Resolution | DL-SCH |
| | (when no valid C-RNTI is available) | |
| Temporary C-RNTI | Msg3 transmission | UL-SCH |
| C-RNTI, MCS(Modulation | Dynamically scheduled unicast transmission | UL-SCH |
| and Coding | | |
| Scheme)-C-RNTI | | |
| C-RNTI | Dynamically scheduled unicast transmission | DL-SCH |
| MCS-C-RNTI | Dynamically scheduled unicast transmission | DL-SCH |
| C-RNTI | Triggering of PDCCH ordered random access | N/A |
| CS(Configued | Configured scheduled unicast transmission | DL-SCH |
| Scheduling)-RNTI | (activation, reactivation and retransmission) | UL-SCH |
| CS-RNTI | Configured scheduled unicast transmission | N/A |
| | (deactivation) | |
| TPC(Transmit Power | PUCCH power control | N/A |
| Control)-PUCCH-RNTI | | |
| TPC-PUSCH-RNTI | PUSCH power control | N/A |
| TPC-SRS-RNTI | SRS trigger and power control | N/A |
| INT(Interruption)-RNTI | Indication pre-emption is DL | N/A |
| SFI(Slot Format | Slot Format Indication on the given cell | N/A |
| Indication)- RNTI | | |
| SP(Semi-persistent)- | Activation of Semi-persistent CSI | N/A |
| CSI(Channel State | reporting on PUSCH | |
| Information)-RNTI | | |

For the PDCCH, a fixed modulation scheme may be used (e.g., quadrature phase shift keying (QPSK)). One PDCCH may include 1, 2, 4, 8, or 16 control channel elements (CCEs) depending on the aggregation level (AL). One CCE may include 6 resource element groups (REGs), and one REG may be defined by one OFDMA symbol and one (P)RB.

The PDCCH may be transmitted in a control resource set (CORESET). The CORESET corresponds to a set of physical resources/parameters used to carry the PDCCH/DCI within a BWP. For example, the CORESET may include a set of REGs with a given numerology (e.g., SCS, CP length, etc.). The CORESET may be configured by system information (e.g., MIB) or UE-specific higher layer (e.g., RRC) signaling. For example, the following parameters/information may be used to configure the CORESET. One UE may be configured with one or more CORESETs, and a plurality of CORESETs may overlap in the time/frequency domain.
controlResourceSetId: this parameter/information indicates the identifier (ID) of the CORESET.
frequencyDomainResources: this parameter/information indicates frequency-domain resources of the CORESET. The frequency-domain resources may be indicated by a bitmap, and each bit corresponds to an RB group (=6 consecutive RBs). For example, the most significant bit (MSB) of the bitmap corresponds to the first RB group in the BWP. An RB group corresponding to a bit with a value of 1 may be allocated as a frequency-domain resource of the CORESET.
duration: this parameter/information indicates time-domain resources of the CORESET. The parameter/information duration may indicate the number of consecutive OFDMA symbols included in the CORESET. For example, duration has a value of 1-3.
cce-REG-MappingType: this parameter/information indicates a CCE-to-REG mapping type. An interleaved type and a non-interleaved type may be supported.
precoderGranularity: this parameter/information indicates a precoder granularity in the frequency domain.
tci-StatesPDCCH: this parameter/information indicates information (e.g., TCI-StateID) on a transmission configuration indication (TCI) state for the PDCCH. The TCI state may be used to provide a quasi-co-location (QCL) relationship between DL RS(s) in an RS set (TCI-state) and a PDCCH DMRS port.
tci-PresentInDCI: this parameter/information indicates whether a TCI field is included in DCI.
pdcch-DMRS-ScramblingID: this parameter/information indicates information used for initialization of a PDCCH DMRS scrambling sequence.

For PDCCH reception, the UE may monitor (e.g., blind decoding) a set of PDCCH candidates in the CORESET. The PDCCH candidate may mean CCE(s) monitored by the UE for PDCCH reception/detection. PDCCH monitoring may be performed in one or more CORESETs in an active DL BWP on each active cell in which the PDCCH monitoring is configured. The set of PDCCH candidates monitored by the UE may be defined as a PDCCH search space (SS) set. The SS set may be classified into a common search space (CSS) set or a UE-specific search space (USS) set.

Table 6 shows PDCCH search spaces.

TABLE 6

| Search Space | Type | RNTI | Lize Case |
|---|---|---|---|
| Type0-PDCCH | Commom | SI-RNTI on a primary | Broadcast of |
| | | cell | System |
| | | | Information |
| Type0A-PDCCH | Common | SI-RNTI on a primary | Broadcast of |
| | | cell | System |
| | | | Information |
| Type1-PDCCH | Common | RA-RNTI or TC-RNTI | Mag2, Msg4 |
| | | on s primary cell | in RACH |
| Type2-PDCCH | Common | P-RNTI on a primary | Paging |
| | | cell | System |
| | | | Information |
| | | | change |
| | | | notification |
| Type3-PDCCH | Common | INT-ANTI, SFI-RNTI, | Group |
| | | TPC-PUSCH-RNTI, | signaling |
| | | TPC-PUCCH-RNTI, | |
| | | TPC-SRS-RNTI, | |
| | | C-RNTI, MCS-C-RNTI | |
| | | or CS-RNTI | |
| UE Specific | UE | C-RNTI, MCS-C-RNTI | UE signaling |
| | Specific | or CS-RNTI | (e.g., PDSCH/ |
| | | | PUSCH) |

The SS set may be configured by system information (e.g., MIB) or UE-specific higher layer (e.g., RRC) signaling. S (e.g., 10) SS sets or less may be configured in each DL BWP of a serving cell. For example, the following parameters/information may be provided for each SS set. Each SS set may be associated with one CORESET, and each CORESET configuration may be associated with one or more SS sets.
searchSpaceId: this parameter/information indicates the ID of the SS set.
   controlResourceSetId: this parameter/information indicates the CORESET associated with the SS set.
   monitoringSlotPeriodicityAndOffset: this parameter/information indicates a PDCCH monitoring periodicity (in a unit of slot) and a PDCCH monitoring offset (in a unit of slot)
monitoringSymbolsWithinSlot: this parameter/information indicates first OFDMA symbol(s) for PDCCH monitoring in a slot in which the PDCCH monitoring is configured. The first OFDMA symbol(s) are indicated by a bitmap, and each bit corresponds to each OFDMA symbol in the slot. The MSB of the bitmap corresponds to the first OFDM symbol in the slot. OFDMA symbol(s) corresponding to bit(s) with a value of 1 corresponds to the first symbol(s) in the CORESET in the slot.
nrofCandidates: this parameter/information indicates the number of PDCCH candidates (e.g., one of 0, 1, 2, 3, 4, 5, 6, and 8) for each AL (where AL={1, 2, 4, 8, 16}).
searchSpaceType: this parameter/information indicates whether the SS type is the CSS or USS.
DCI format: this parameter/information indicates the DCI format of a PDCCH candidate.

The UE may monitor PDCCH candidates in one or more SS sets in a slot according to the configuration of the CORESET/SS set. An occasion (e.g., time/frequency resource) to monitor PDCCH candidates is defined as a PDCCH (monitoring) occasion. One or more PDCCH (monitoring) occasions may be configured within a slot.

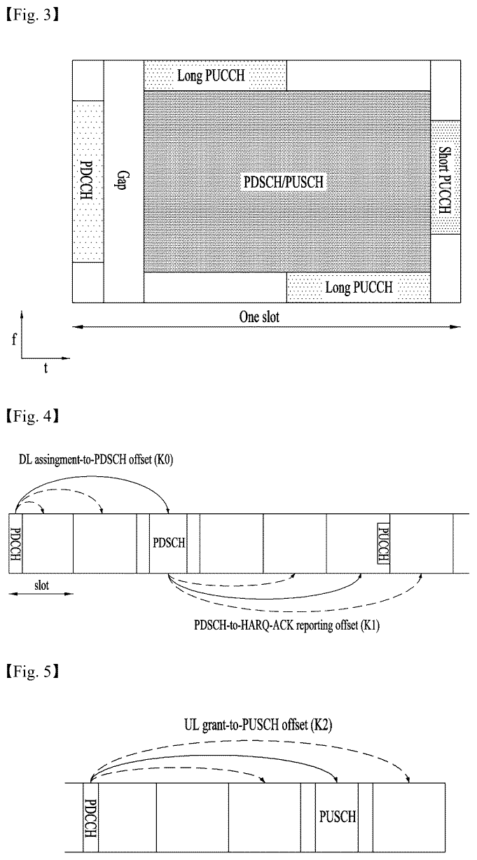

FIG. 4 illustrates an ACK/NACK transmission process.

Referring to FIG. 4, the UE may detect a PDCCH in slot #n. The PDCCH includes DL scheduling information (e.g., DCI format 1_0 or DCI format 1_1). The PDCCH indicates a DL assignment-to-PDSCH offset, K0 and a PDSCH-to-HARQ-ACK reporting offset, K1. For example, DCI format 1_0 or DCI format 1_1 may include the following information.
Frequency domain resource assignment: Indicates an RB set assigned to a PDSCH.
Time domain resource assignment: Indicates K0 and the starting position (e.g., OFDM symbol index) and length (e.g., the number of OFDM symbols) of the PDSCH in a slot.
PDSCH-to-HARQ_feedback timing indicator: Indicates K1.
HARQ process number (4 bits): Indicates HARQ process identify (ID) for data (e.g. PDSCH or TB)
PUCCH resource indicator (PRI): Indicates a PUCCH resource to be used for UCI transmission from among multiple PUCCH resources within a PUCCH resource set.

After receiving a PDSCH in slot #(n+K0) according to the scheduling information of slot #n, the UE may transmit UCI on a PUCCH in slot #(n+K1). The UCI includes an HARQ-ACK response to the PDSCH. In the case where the PDSCH is configured to carry one TB at maximum, the HARQ-ACK response may be configured in one bit. In the case where the PDSCH is configured to carry up to two TBs, the HARQ-ACK response may be configured in two bits if spatial bundling is not configured and in one bit if spatial bundling is configured. When slot #(n+K1) is designated as an HARQ-ACK transmission timing for a plurality of PDSCHs, UCI transmitted in slot #(n+K1) includes HARQ-ACK responses to the plurality of PDSCHs.

FIG. 5 illustrates an exemplary PUSCH transmission process.

Referring to FIG. 5, the UE may detect a PDCCH in slot #n. The PDCCH may include UL scheduling information (e.g., DCI format 0_0 or DCI format 0_1). DCI format 0_0 and DCI format 0_1 may include the following information.
Frequency domain resource assignment: Indicates an RB set allocated to a PUSCH.
Time domain resource assignment: Specifies a slot offset K2 indicating the starting position (e.g., symbol index) and length (e.g., the number of OFDM symbols) of the PUSCH in a slot. The starting symbol and length of the PUSCH may be indicated by a start and length indicator value (SLIV), or separately.

The UE may then transmit a PUSCH in slot #(n+K2) according to the scheduling information in slot #n. The PUSCH includes a UL-SCH TB. When a PUCCH transmission time and a PUSCH transmission time overlap, UCI may be transmitted through PUSCH (PUSCH piggyback).

### 1. DCI for Scheduling PDSCHs or PUSCHs on Multiple Serving Cells

The above contents are applicable in combination with methods proposed in the present disclosure, which will be described later. Alternatively, the contents may clarify the technical features of the methods proposed in the present disclosure.

In addition, the following methods may be equally applied to the above-described NR system or shared spectrum (licensed bands). Thus, it is obvious that the terms, expressions, and structures in this document may be modified to be suitable for the system in order to implement the technical idea of the present disclosure in the corresponding system.

In a CA situation in which a plurality of cells are configured, to reduce a DCI overhead required for PDSCH/PUSCH scheduling, a multi-cell scheduling (multi-CC scheduling) method for simultaneously scheduling a plurality of serving cells/CCs with single DCI (based on justification shown in Table 7) in Rel-18 may be considered. In this specification, the expression “scheduling a plurality of cells” may be understood as “scheduling a PDSCH or PUSCH to be transmitted in each of the plurality of cells.” In other words, multi-cell DCI is DCI for scheduling PDSCHs or PUSCHs on different cells.

Table 7 shows a justification for supporting DCI for this purpose in Rel-18 and may be understood as one of motivations for introducing such DCI (PDCCH).

TABLE 7
Excerpt from RP-220834

NR supports a wide range of spectrum in different frequency ranges.
It is expected that there will be increasing availability of spectrum in the
market for 5G Advanced possibly due to re-farming from the bands
originally used for previous cellular generation networks. Especially for
low frequency FRI bands, the available spectrum blocks tend to be more
fragmented and scattered with narrower bandwidth. For FR2 bands and
some FR1 bands, the available spectrum can be wider such that intra-
band multi-carrier operation is necessary. To meet different spectrum
needs, it is important to ensure that these scattered spectrum bands or
wider bandwidth spectrum can be utilized in a more spectral/power
efficient and flexible manner, thus providing higher throughput and
decent coverage in the network.
One motivation is to increase flexibility and spectral/power efficiency on
scheduling data over multiple cells including intra-band cells and inter-
band cells. The current scheduling mechanism only allows scheduling of
single cell PUSCH/PDSCH per a scheduling DCI. With more available
scattered spectrum bands or wider bandwidth spectrum, the need of
simultaneous scheduling of multiple cells is expected to be increasing.
To reduce the control overhead, it is beneficial to extend from single-cell
scheduling to multi-cell PUSCH/PDSCH scheduling with a single
scheduling DCI. Meanwhile, trade-off between overhead saving and
scheduling restriction has to be taken into account.

Accordingly, the present disclosure proposes a method of configuring and interpreting fields within DCI to design a structure of DCI for multi-cell scheduling (multi-cell DCI).

The number of cells that a multi-cell DCI schedules simultaneously is large, and thus when each field of the DCI is separately configured for each cell, a size of the DCI may increase significantly. Due to the characteristics of a polar code used for DCI encoding, the size of the DCI needs to be adjusted to be less than or equal to a certain number of bits (e.g., up to 140 bits). On the other hand, when each field of the corresponding DCI is configured commonly for all cells to be scheduled (common/shared configuration), the size of the DCI may be reduced, but scheduling flexibility may be significantly reduced. Therefore, depending on the characteristics of each DCI field, it is necessary to appropriately adjust separate configuration and common configuration for each scheduled cell.

For reference, Table 8 shows DCI fields related to the present disclosure, described in the 3GPP TS 38.212 document.

TABLE 8
For transport block 1:
Modulation and coding scheme - 5 bits as defined in Clause 5.1.3.1 of
[6, TS 38.214]
New data indicator - 1 bit if the number of scheduled PDSCH indicated
by the Time domain resource assignment field is 1; otherwise 2, 3, 4, 5,
6, 7 or 8 bits determined based on the maximum number of schedulable
PDSCH among all entries in the higher layer parameter pdsch-
TimeDomainResourceAllocationListForMultiPDSCH, where each bit
corresponds to one scheduled PDSCH as defined in clause 5.1.3 in
[6, TS 38.214].
Redundancy version - number of bits determined by the following:
2 bits as defined in Table 7.3.1.1.1-2 if the number of scheduled PDSCH
indicated by the Time domain resource assignment field is 1;
otherwise 2, 3, 4, 5, 6, 7 or 8 bits determined by the maximum number
sof chedulable PDSCHs among all entries in the higher layer parameter
pdsch-TimeDomainResourceAllocationListForMultiPDSCH, where
each bit corresponds to one scheduled PDSCH as defined in clause 5.1.3
in [6, TS 38.214] and redundancy version is determined according to
Table 7.3.1.1.2-34.

When a time domain resource allocation (TDRA) field of multi-cell DCI is configured, one or more of the following methods may be applied.

### Method to be Applied to Each Field

### Method 1: Shared-Reference-Cell

Method in which only one field is configured within multi-cell DCI, a value indicated by the corresponding DCI field is applied only to a specific reference cell (e.g., a cell to which the corresponding DCI is transmitted, a cell with the lowest or highest cell index, or a cell indicated by a CIF field value) (from among cells that are scheduled through multi-cell DCI and for which an operation is configured according to indication of the corresponding DCI field), and a specific default value predefined/configured is applied to the remaining cells.

### Method 2: Shared-Single-Cell

Method in which only (at most) one field is configured within multi-cell DCI, the corresponding DCI field is configured only when one cell is scheduled (through multi-cell DCI) (a value indicated by the corresponding field is applied to the one cell), and the corresponding DCI field is not configured and is omitted when multiple cells are scheduled (in this case, a specific default value that is predefined/configured is applied to the corresponding multiple cells).

### Method 3: Shared-Cell-Common

Method in which only one field is configured within multi-cell DCI, and a value indicated by the corresponding DCI field is commonly applied to all cells (scheduled through multi-cell DCI).

### Method 4: Shared-State-Extension

Method in which only one field is configured within multi-cell DCI, and each of multiple states to be indicated by the corresponding DCI field is configured/set by a combination of multiple pieces of information about multiple cells (not information about a single cell).

### Method 5: Separate

Method in which a number of fields (within the DCI) equal to the number of cells scheduled through multi-cell DCI (with an operation configured according to the corresponding DCI field instruction) is configured, a separate field corresponds to each of the scheduled cells, and a value indicated by the corresponding field is applied to the corresponding cell.

### Method 6: Separate-Equal

Method in which a number of fields (within the DCI) equal to the number of cells scheduled through multi-cell DCI (with an operation configured according to the corresponding DCI field instruction) is configured, a separate field corresponds to each of the scheduled cells/TBs, and a value indicated by the corresponding field is applied to the corresponding cell However, separate fields corresponding to respective scheduled cells have the same size.

### Method 7: Separate-Delta

Method in which the corresponding DCI field is separately configured for each cell/fB scheduled through multi-cell DCI (for which an operation according to the corresponding DCI field instruction is configured), full information is indicated only for one specific reference cell (for example, a cell to which the corresponding DCI is transmitted, a cell with the lowest or highest cell index, or a cell indicated by the CIF field value) (from among cells that are scheduled through multi-cell DCI and for which an operation according to the corresponding DCI field instruction is configured), and delta information regarding an amount of change compared to the corresponding full information is indicated for the remaining cells.

The expression “cell” within the specification may be interpreted depending on the context. For example, a cell may mean a serving cell. The cell may include one DL component carrier (DL CC) and 0 to 2 UL CCs, but the methods described below are not limited thereto. In the expressions described below, cells and CC may be used interchangeably unless otherwise specified. The cells/CCs may be replaced with (active) BWPs within the serving cell and applied. Unless otherwise specified, in the methods described below, the cell/CC may be used as a concept encompassing primary cell (PCell), secondary cell (SCell), primary SCell (PS cell), and the like, which may be configured/expressed in a carrier aggregation (CA)/dual connectivity (DC) scenario.

In the specification, a (specific) reference cell may be determined/configured as a cell to which the corresponding DCI is transmitted, a cell with the lowest (or highest) cell index, or a cell indicated by a CIF field value from among cells scheduled via a single multi-cell DCI. Alternatively, the (specific) reference cell may be determined/configured as a cell to which the corresponding DCI is transmitted, a cell with the lowest (or highest) cell index, or a cell indicated by a CIF field value from among cells to be scheduled via single multi-cell DCI (i.e., not a cell scheduled at a specific time or with a specific control channel). Alternatively, the (specific) reference cell may be one specific cell configured through RRC signaling from among cells configured in a UE (or from among cells to be scheduled through multi-cell DCI).

When scheduling cells of multi-cell DCI (cells in which a UE monitors the multi-cell DCI) are different from each other, different reference cells may be configured. For example, in a scenario in which scheduling cells time-vary, reference cells may be separately configured for each scheduling cell. Alternatively, the reference cell may be (re)configured when the scheduling cell changes. When a scheduling cell changes, the reference cell may be (re)configured not only when a combination of cells scheduled via the corresponding multi-cell DCI changes but also when the combination does not change. Depending on a carrier type and/or SCS size of a scheduling cell (or scheduled cell(s)) for the multi-cell DCI, a reference cell for the multi-cell DCI may be (re)configured (or a reference cell may be separately configured for each carrier type and/or SCS size).

In the present disclosure, a reference cell may mean a cell with the lowest (or highest) cell index or a cell with the earliest (or latest) indicated PDSCH/PUSCH transmission starting symbol time within a combination of cells (co-scheduled cell set or each cell subgroup) that are simultaneously scheduled through the same multi-cell DCI. When there are multiple cells with the earliest (or latest) PDSCH/PUSCH starting symbol time, the cell with the lowest (or highest) cell index from among the corresponding multiple cells may be configured as the reference cell. Alternatively, the reference cell may be a cell with the earliest (or latest) indicated PDSCH/PUSCH transmission ending symbol time from among a combination of simultaneously scheduled cells. When there are multiple cells with the earliest (or latest) PDSCH/PUSCH ending symbol time, the cell with the lowest (or highest) cell index from among the corresponding multiple cells may be configured as the reference cell. Alternatively, the reference cell may mean a cell prespecified through a cell indicated by a CIF field value or RRC within the combination of the simultaneously scheduled cells. Alternatively, the reference cell may mean a cell with the lowest (or highest) cell index within a schedulable cell set of all cells schedulable via any multi-cell DCI, a cell indicated by a CIF field value, a cell to which multi-cell DCI is transmitted, or a cell previously designated via RRC.

In the case of a DCI field to which a shared-reference-cell method, a shared-cell-common method, and a shared-state-extension method proposed in the present disclosure are applied, only one field may be configured within multi-cell DCI (i.e., commonly applied to all cells belonging to the co-scheduled cell set). Alternatively, in a state in which all cells belonging to a set of simultaneously scheduled cells (a co-scheduled cell set) are grouped into one or more cell subgroups (which may be used interchangeably with “cell group”), one (commonly applied) DCI field may be configured for each cell subgroup (separate/independent fields may be configured between cell subgroups). Alternatively, in a state in which all cells belonging to a schedulable cell set may be grouped into one or more cell subgroups, one DCI field (commonly applied) may be configured for each cell subgroup (separate/independent fields may be configured between cell subgroups). Accordingly, a shared-reference-cell method, a shared-cell-common method, and a shared-state-extension method, and the configuration/instruction method of fields/information based thereon may be applied to each cell subgroup. Each cell subgroup may be configured/set up by a specific cell or a specific plurality of cells belonging to a set of simultaneously scheduled cells or a set of schedulable cells (e.g., some or all of the cells belonging to the co-scheduled cell set or the schedulable cell set).

### 1.1 Method of Configuring TDRA Field of UL (or DL) DCI for Multi-Cell PUSCH (or PDSCH) Scheduling

This section describes a method of configuring a new data indicator (NDI) field to be included in the corresponding DCI to design a multi-cell DCI structure. Multi-cell PUSCH scheduling means an operation of scheduling PUSCHs on different cells. Multi-cell PDSCH scheduling means an operation of scheduling PDSCHs on different cells.

An NDI field of multi-cell DCI may be configured in one of the following options based on the method applicable to each field described above.

### 1.1-1 Opt 1: Application of Separate-Equal Method

A separate NDI field may be configured for each cell scheduled via multi-cell DCI. The size of each separate field may vary depending on the number of cells scheduled. For example, the separate field size may be configured to be less when the number of scheduled cells exceeds N than when the number of scheduled cells is N (e.g. N=1).

### 1.1-2 Opt 2: Application of Shared-Reference-Cell Method

The corresponding NDI field is transmitted/applied only to the PDSCH (or PUSCH) on a specific reference cell (from among cells scheduled via multi-cell DCI). The UE may operate assuming that there is no NDI field and that it is an initial transmission for the PDSCH (or PUSCH) on the remaining cells other than the reference cell. In this case, the reference cell may be predefined or preconfigured.

### 1.1-3 Opt 3: Application of Shared-Single-Cell Method

The corresponding NDI field is configured only when one cell is scheduled (via multi-cell DCI). A value indicated through the corresponding NDI field is applied to the corresponding one cell. When multiple cells are scheduled, the NDI field may not be configured and may be omitted. In this case, the UE may operate assuming initial transmission for all scheduled multiple cells.

### 1.1-4 Opt 4: Application of Shared-Cell-Common Method

A value indicated by the corresponding NDI field may be commonly applied to the PDSCH (or PUSCH) on all cells (scheduled via multi-cell DCI). Depending on this value, the UE may operate assuming that the PDSCH (or PUSCH) on all cells is either an initial transmission or a retransmission.
Embodiment 1: For PDSCH (or PUSCH) on all cells scheduled via multi-cell DCI, one k-bit NDI field may be configured (e.g., k=1). When the corresponding NDI field means an initial transmission, the UE operates assuming all PDSCHs (or PUSCHs) scheduled through the multi-cell DCI with the corresponding configured NDI field as initial transmission. When the corresponding NDI field means a retransmission, the UE operates assuming that all PDSCHs (or PUSCHs) scheduled through the multi-cell DCI with the corresponding configured NDI field are retransmissions.
Embodiment 2: For PDSCH (or PUSCH) on all cells scheduled via multi-cell DCI, one k-bit NDI field may be configured (e.g., k=1). When the corresponding NDI field means initial transmission, the UE operates assuming all PDSCHs (or PUSCHs) scheduled through the multi-cell DCI with the corresponding configured NDI field as initial transmission. When the corresponding NDI field means a retransmission, the UE operates assuming that all PDSCHs (or PUSCHs) scheduled through the multi-cell DCI in which the corresponding NDI field is configured are retransmissions. When the multi-cell DCI in which the corresponding NDI field is configured/included is used interchangeably with the conventional single-cell DCI, the corresponding NDI field may (according to a separate configuration or rule) indicate whether to perform an initial transmission or a retransmission for the PDSCHs (or PUSCHs) on the set of cells scheduled with the multi-cell DCI. Alternatively, this may indicate whether to initialize or retransmit the PDSCH (or PUSCH) on a cell scheduled with a single-cell DCI.

When an initial transmission or a retransmission for PDSCH (or PUSCH) on all multi-cell scheduled cells may be configured using one NDI field (e.g., 1 bit field) like 1.1-4 Opt 4 above, the NDI field may be operated together with the conventional single-cell DCI in one of the operation examples 1 and 2 below.

### Operation Example 1

Whether or not NDI toggle of multi-cell DCI is relevant only for an initial transmission and a retransmission for cells scheduled with multi-cell DCI, and has no relation to transmission due to single-cell DCI.
Whether to toggle NDI of single-cell DCI may be determined by comparison with NDI of previous multi-cell DCI or comparison with previous single-cell DCI (depending on whether single-cell DCI exists between consecutive single-cell DCI and whether HARQ ID of single-cell DCI and multi-cell DCI are the same).
When there is no transmission (corresponding to multi-cell DCI) between two consecutive single-cell transmissions (in this case, the case of missing multi-cell DCI is also included), the NDI of the single-cell DCI indicates whether it is an initial transmission or a retransmission of the single-cell transmission.
When there is a multi-cell transmission between two consecutive single-cell transmissions, and the HARQ ID of the single-cell DCI is different from the HARQ ID of the multi-cell DCI, the NDI of the single-cell DCI indicates whether it is an initial transmission or a retransmission of the single-cell transmission. When the HARQ ID of the single-cell DCI is the same as the HARQ ID of the multi-cell DCI, and the NDI of the single-cell DCI and the NDI of the multi-cell DCI are the same, it is determined to be a retransmission for the multi-cell DCI.
Alternatively, it may be expressed in chronological order as below. In the examples below, multi-cell DCI and single-cell DCI are represented as M-DCI and S-DCI, respectively. This explanation assumes that M-DCI or S-DCI transmission/reception occurs in the order of slot A->X->Y->Z1->Z2.
In M-DCI, when 1-bit NDI is configured for all cells to be scheduled, the NDI value of M-DCI is toggled only between M-DCIs. For example,
When S-DCI NDI=0 received in slot A, a TB of a specific CC corresponds to an initial transmission.
When M-DCI NDI=0 received in slot X, all multi-CC TBs scheduled with M-DCI correspond to initial transmissions. For each HARQ ID mapped to a multi-CC TB, all multi-CC TBs scheduled with M-DCI correspond to initial transmission, regardless of whether the NDI value of S-DCI of slot A indicating the corresponding HARQ ID is 0 or 1.
When M-DCI NDI=1 received in slot Y, all multi-CC TBs scheduled with M-DCI correspond to initial transmissions.
When M-DCI NDI=1 received in slot Z1, all multi-CC TBs scheduled with M-DCI correspond to retransmissions. When the M-DCI of slot Y schedules TBs for 4 CCs, the M-DCI of slot Z1 may schedule retransmission of TBs for 4 or fewer CCs.
Regarding S-DCI received in slot Z2, when NDI=1, and S-DCI of slot Z2 Z1 has the same HARQ ID as one of CC of slot Y or slot Z1, the UE recognizes it as a retransmission of TB for CC of slot Y or slot Z1. Even if M-DCI is missed, NDI is toggled for slot A, and thus the UE considers a new TB to be scheduled.—Regarding S-DCI received in slot Z2, when NDI=0, and S-DCI of slot Z2 Z1 has the same HARQ ID as one of CC of slot Y or slot Z1, the NDI is not toggled compared to slot A, and thus the UE determines it as a retransmission of TB scheduled in slot A. When there is an M-DCI between slot A and slot Z2, a BS may not configure NDI=0.

### Operation Example 2

In operation example 2, s-NDI and m-NDI may mean an NDI field of single-cell DCI and an NDI field of multi-cell DCI, respectively. According to a rule such as Method 1/1A/1B or Method 2 below, whether transmission on all cells scheduled for multi-cell corresponds to an initial transmission or a retransmission may be configured/determined using one NDI field (e.g., 1 bit field).
Method 1: When the UE receives s-NDI_1->m-NDI->s-NDI_2 in the order, the s-NDI_1 value is determined to be toggled by m-NDI, and s-NDI_2 is compared with the toggled s-NDI_1 as the standard (i.e., m-NDI may not indicate the actual NDI value).
Method 1A: s-DCI_2 Supports Retransmission of s-DCI_1
When receiving in the order of 0->1->s-NDI_2 for the same HARQ ID, the operation is as shown in Tables 9 to 12 below.

TABLE 9

| | | | |
|---|---|---|---|
| NDI value | 0 | 1 | s-NDI_2 |
| indicated in DCI | | | |
| Actual NDI value | 0 | 1 (toggled) | When s-NDI_2 = 0, |
| for the | | | retransmission of s-DCI |
| corresponding | | | When s-NDI_2 = 1, |
| HARQ ID | | | retransmission of m-DCI |

TABLE 10

| | | | |
|---|---|---|---|
| NDI value | 0 | 0 | 1 |
| indicated in DCI | | | |
| Actual NDI | 0 | 1 (toggled) | When s-NDI_2 = 1, |
| value for the | | | retransmission of s-DCI |
| corresponding | | | When s-NDI_2 = 0, |
| HARQ ID | | | retransmission of m-DCI |

TABLE 11

| | | | |
|---|---|---|---|
| NDI value | 1 | 1 | s-NDI_2 |
| indicated in DCI | | | |
| Actual NDI | 1 | 0 (toggled) | When s-NDI_2 = 1, |
| value for the | | | retransmission of s-DCI |
| corresponding | | | When s-NDI_2 = 0, |
| HARQ ID | | | retransmission of m-DCI |

TABLE 12

| | | | |
|---|---|---|---|
| NDI value | 1 | 0 | 1 |
| indicated in DCI | | | |
| Actual NDI | 1 | 0 (toggled) | When s-NDI_2 = 1, |
| value for the | | | retransmission of s-DCI |
| corresponding | | | When s-NDI_2 = 0, |
| HARQ ID | | | retransmission of m-DCI |

Method 1B: s-DCI_2 does not support retransmission of s-DCI_1
When receiving in the order of 0->1->s-NDI_2 for the same HARQ ID, the operation is as shown in Tables 13 to 16 below.

TABLE 13

| | | | |
|---|---|---|---|
| NDI value | 0 | 1 | s-NDI_2 |
| indicated in | | | |
| DCI | | | |
| Actual NDI | 0 | 1 (toggled) | When s-NDI_2 = 0, initial |
| value for the | | | transmission |
| corresponding | | | When s-NDI_2 = 1, |
| HARQ ID | | | retransmission of m-DCI |

TABLE 14

| | | | |
|---|---|---|---|
| NDI value | 0 | 0 | 1 |
| indicated in | | | |
| DCI | | | |
| Actual NDI | 0 | 1 (toggled) | When s-NDI_2 = 0, initial |
| value for the | | | transmission |
| corresponding | | | When s-NDI_2 = 1, |
| HARQ ID | | | retransmission of m-DCI |

TABLE 15

| | | | |
|---|---|---|---|
| NDI value | 1 | 1 | s-NDI_2 |
| indicated in | | | |
| DCI | | | |
| Actual NDI | 1 | 0 (toggled) | When s-NDI_2 = 1, initial |
| value for the | | | transmission |
| corresponding | | | When s-NDI_2 = 0, |
| HARQ ID | | | retransmission of m-DCI |

TABLE 16

| | | | |
|---|---|---|---|
| NDI value | 1 | 0 | 1 |
| indicated in | | | |
| DCI | | | |
| Actual NDI | 1 | 0 (toggled) | When s-NDI_2 = 1, initial |
| value for the | | | transmission |
| corresponding | | | When s-NDI_2 = 0, |
| HARQ ID | | | retransmission of m-DCI |

Method 2: When the UE receives s-NDI_1->m-NDI->s-NDI_2 in the order, m-NDI and s-NDI_2 are compared with each other regardless of the s-NDI_1 value (i.e., m-NDI always indicates the actual NDI value).
When receiving in the order of 0->1->s-NDI_2 for the same HARQ ID, the operation is as shown in Tables 17 to 20 below.

TABLE 17

| | | | |
|---|---|---|---|
| NDI value | 0 | 1 | s-NDI_2 |
| indicated in | | | |
| DCI | | | |
| Actual NDI | 0 | 1 | When s-NDI_2 = 0, initial |
| value for the | | | transmission |
| corresponding | | | When s-NDI_2 = 1, |
| HARQ ID | | | retransmission of m-DCI |

TABLE 18

| | | | |
|---|---|---|---|
| NDI value | 0 | 0 | 1 |
| indicated in | | | |
| DCI | | | |
| Actual NDI | 0 | 0 | When s-NDI_2 = 1, |
| value for the | | | initial transmission |
| corresponding | | | When s-NDI_2 = 0, |
| HARQ ID | | | retransmission of m-DCI |

TABLE 19

| | | | |
|---|---|---|---|
| NDI value | 1 | 1 | s-NDI_2 |
| indicated in | | | |
| DCI | | | |
| Actual NDI | 1 | 1 | When s-NDI_2 = 0, |
| value for the | | | initial transmission |
| corresponding | | | When s-NDI_2 = 1, |
| HARQ ID | | | retransmission of m-DCI |

TABLE 20

| | | | |
|---|---|---|---|
| NDI value | 1 | 0 | 1 |
| indicated in DCI | | | |
| Actual NDI | 1 | 0 | When s-NDI_2 = 1, |
| value for the | | | initial transmission |
| corresponding | | | When s-NDI_2 = 0, |
| HARQ ID | | | retransmission of m-DCI |

### 1.2 Method of Configuring RV Field of UL (or DL) DCI for Multi-Cell PUSCH (or PDSCH) Scheduling

This section describes a method of configuring redundancy version (RV) and HARQ process number (HPN) fields to be provided in DCI to design a multi-cell DCI structure. An RV field of multi-cell DCI may be configured in one of the following options based on the method applicable to each field described above.

### 1.2-1 Opt 1: Application of Separate-Equal Method

A separate RV field may be configured for each cell scheduled through multi-cell DCI (TB transmitted through PDSCH or PUSCH on the corresponding cell), and the size of the corresponding separate field may be configured to be the same for each scheduled cell. Alternatively, separate field sizes may vary depending on the total number of cells (TB) scheduled. For example, a separate field size may be smaller when the scheduled cell exceeds n pcs than when the scheduled cell is equal to or less than N (e.g. N=1).
Embodiment 1: A separate RV field may be configured for each cell scheduled through multi-cell DCI, and (regardless of the number of scheduled cells) the size of the corresponding separate field may be configured as a 1-bit RV field for each TB of each cell.
Embodiment 2: A separate RV field is configured for each cell scheduled through multi-cell DCI, and for a cell configured to allow up to 2 TB transmission on a single PDSCH/PUSCH, a 1-bit RV field may be configured for each TB, and for a cell configured to allow up to 1 TB transmission on a single PDSCH/PUSCH, a 2-bit RV field may be configured for each TB.
Embodiment 3: A separate RV field may be configured for each cell scheduled through multi-cell DCI, and in this case, when the number of scheduled cells is 1, a 2-bit RV field may be configured for the corresponding cell (for each TB transmitted through PDSCH/PUSCH on the corresponding cell), and when the number of scheduled cells is 2 or more, a 1-bit RV field may be configured for each cell (for each TB transmitted through PDSCH/PUSCH on the corresponding cell).
Embodiment 4: A separate RV field may be configured for each cell scheduled through multi-cell DCI, and in this case, when the number of scheduled cells is 1, a 2-bit RV field may be configured for the corresponding cell (for each TB transmitted through PDSCH/PUSCH on the corresponding cell), and when the number of scheduled cells is 2 or more, a 1-bit RV field may be configured for each TB for a cell configured to enable transmission of up to 2 TBs (same as Embodiment 2), and a 2-bit RV field may be configured for each TB for a cell configured to enable transmission of 1 TB.

### 1.2-2 Opt 2: Application of Shared-Reference-Cell Method

The corresponding RV field is transmitted/applied only to the PDSCH (or PUSCH) on a specific reference cell (from among cells scheduled via multi-cell DCI). The UE may operate assuming one specific RV value (e.g., RV=‘00’ or RV value/index 0) while assuming that there is no RV field for PDSCH (or PUSCH) on cells other than the reference cell. In this case, the reference cell may be predefined or preconfigured.

### 1.2-3 Opt 3: Application of Shared-Single-Cell Method

An RV field (for TB transmitted via PDSCH or PUSCH on the cell) is configured (a value indicated by the RV field is applied to the cell) only when one cell is scheduled (via multi-cell DCI). When multiple cells are scheduled, the RV field may not be configured and may be omitted, in which case the same specific RV value (e.g., RV=‘00’ or RV value/index 0) may be applied to all of the multiple cells (TBs transmitted via PDSCH or PUSCH on the cell).

### 1.2-4 Opt 4: Application of Shared-Cell-Common Method

A value indicated by the corresponding RV field may be commonly applied to TBs transmitted through PDSCH (or PUSCH) on all cells (scheduled through multi-cell DCI), and a specific RV value may be equally applied to TBs transmitted through PDSCH (or PUSCH) on all cells according to the value.
Embodiment 1: For PDSCHs (or PUSCHs) on all cells scheduled via multi-cell DCI, one k-bit RV field may be configured (e.g., k=1 or k=2). The value indicated through the corresponding RV field may be applied commonly to all of the cells.
Embodiment 2: A combination of cells (or cell group) that share the same RV field/information (using the shared-cell-common method) is predefined/configured. A separate RV field may be configured for each cell group (cells belonging to each cell group share one RV field, and values indicated through the corresponding field are commonly applied). In this case, multiple cell groups may be defined/configured, and the cell groups may be configured/reconfigured using RRC and/or MAC-CE.

As described above, an RV field may be configured within multi-cell DCI by applying the shared-cell-common method to each cell subgroup (belonging to a co-scheduled cell set). Accordingly, one RV field may be configured for each cell subgroup (or one RV field for each TB index), and a value indicated through the corresponding field may be commonly applied to cells belonging to the cell subgroup.

A cell configured to enable PDSCH transmission including up to 2 TBs (2-TB cell) and a cell configured to enable only PDSCH transmission including up to 1 TB (1-TB cell) may belong to the same co-scheduled cell set. In this case, a configuration restriction may be used such that one cell subgroup includes only 2-TB cells or only 1-TB cells (i.e., 2-TB cells and 1-TB cells do not belong to the same cell subgroup). In this case, for a cell subgroup including only 2-TB cells, (two) commonly applied RV fields/information (for the corresponding TB index on all cells belonging to the corresponding cell subgroup) may be configured/indicated for each TB index. Alternatively, one RV field/information that is commonly applied to all TB indexes (i.e., all TB indexes on all cells belonging to the corresponding cell subgroup) may be configured/indicated.

Alternatively, a configuration may be allowed for the 2-TB cell and the 1-TB cell to belong to the same single cell subgroup, in which case, for the cell subgroup, a first RV field/information commonly applied to the first TB index on the 2-TB cell and a single TB on the 1-TB cell may be configured/indicated, and a second RV field/information commonly applied to the second TB index on the 2-TB cell may be configured/indicated. Alternatively, one RV field/information that is commonly applied to all TBs (all TB indexes on all cells belonging to the corresponding cell subgroup) may be configured/indicated.

### 1.2-5 Opt 4: Application of Shared-Cell-Common Method and Separation Method

A separation method may be applied to each cell scheduled through multi-cell DCI, and a shared-cell-common method may be applied to TBs within a cell. In detail, only one RV field is configured for multiple TBs transmitted via PDSCH on the same cell. The value indicated through the corresponding field may be applied commonly to the corresponding multiple TBs. Separate RV fields/information may be configured/indicated between different cells. This method may also be applied optionally only when 2 TBs are configured for each cell. For example, the present option may be applied only to multi-cell DCI for DL for PDSCH scheduling. Alternatively, the present option may be selectively applied only to cells in which 2 TB transfer is enabled/allowed for each cell.

In the proposed method in which shared-cell-common (or shared-single-cell or shared-reference-cell) is (partially) applied as described in 1.2-2 to 1.2-5 above, the same RV field value may be configured and/or applied for multiple cells (and/or for multiple TBs configured in the corresponding cell) depending on the conditions described above. That is, the multiple cells are configured to the same CC group. The same RV field value may be applied to cells (and TBs of the corresponding cell) belonging to the corresponding CC group. However, when some of the multiple cells are configured to a maximum of 2 TBs and others are configured to (a maximum of) 1 TB, the same RV field may or may not be applied to those cells (or TBs). In detail, one of the following Alts may be configured:

Alt 1: When some of the multiple cells grouped into the same CC group are configured to a maximum of 2 TBs and others are configured to (maximum) 1 TB, one RV field value configured in the cells may be commonly applied only to a TB with the lowest index of each cell. For example, in a cell with 2 TBs configured, the RV field value may be applied only to a first TB, and in a cell with 1 TB configured, the RV field value may be applied to the corresponding TB.

Alt 2: When multiple cells grouped into the same CC group are all configured to 2 TBs, common RV information may be indicated by the same TB index. Alternatively, only a single RV information to be commonly applied to all CCs and all TBs grouped into a CC group (regardless of the max TB number configured for each CC) may be indicated.

A DCI field size when the separation method is applied may also be determined by the following method.

For reference, for a specific DCI field in the existing single-cell DCI, the size of the corresponding DCI field may be configured to L=ceil {log₂(N)} bits (in a state in which N states/indexes are to be indicated through the corresponding DCI field), and in this case, L may be configured to a different (or the same) value for each cell.

When the RV field in the multi-cell DCI is configured based on the separation method, first, for each of a plurality of (for example, N_co) co-scheduled cell sets configured in the schedulable cell set, the sum L_sum of L values configured for each of the cells belonging to the corresponding co-scheduled cell set may be calculated, and the maximum value of the N_co L_sum values calculated for each of the N_co co-scheduled cell sets may be determined as a size of the RV field (configured in the multi-cell DCI).

In this case, the “L value configured for each” may mean the (maximum) RV number defined or configured (separately) for each co-scheduled cell set. In other words, the “L value configured for each” means a separate (configured) value for PDSCH/PUSCH scheduled via multi-cell DCI. The “L value configured for each” may be configured to be equal to or less than/less than the maximum value of the number of RVs to be conventionally configured for each cell (i.e., RVs for PDSCH/PUSCH via single-cell DCI).

When there is no separate configuration (for multi-cell DCI), the “L value configured for each” may be the (maximum) RV number for single-cell DCI to be defined/configured for each cell (or pre-defined/configured).

### 1.3 Method of Configuring HPN Field of UL (or DL) DCI for Multi-Cell PUSCH (or PDSCH) Scheduling

This section describes a method of configuring a HARQ process number (HPN) field to be provided in DCI to design a multi-cell DCI structure. An HPN field of multi-cell DCI may be configured in one of the following options based on the method applicable to each field described above.

### 1.3-1 Opt 1: Application of Separate-Equal Method or Separation Method

A separate HPN field may be configured for each cell scheduled via multi-cell DCI. The size of the corresponding separate HPN field may vary depending on the number of cells scheduled. For example, a separate HPN field size may be smaller when the scheduled cell exceeds n pcs than when the scheduled cell is equal to or less than N (e.g. N=1). When the maximum number of HPNs for a specific cell is configured to M and only one corresponding cell is scheduled via multi-cell DCI, an HPN field of K=ceil{log₂(M)} (or 4) bits is configured, and a value of one of the M HPNs is indicated through the corresponding field. In case multiple cells (including the cell) are scheduled via multi-cell DCI, the HPN field (corresponding to the cell) may be configured with only L bits (L<K) (or K bits), and in this case, 2^{L} (or M) HPN values (one HPN value thereamong) may be indicated via the corresponding field.
When the maximum HPN number M configured for each cell is different, the HPN field for each cell may be configured with the minimum number of bits (e.g. ceil(log₂M)) that matches the M value configured for each cell. Alternatively, the HPN field for each cell (for cells scheduled via multi-cell DCI) may be configured (with the same size) to the minimum number of bits that matches the maximum/minimum values from among the maximum HPN numbers configured for each cell. In the latter case, when the HPN field is configured to the minimum number of bits L=ceil{log₂ (N_min)}, which is the minimum value N_min from among the maximum HPN values for each cell, min{2^{L}, M} HPN values (one HPN value thereamong) may be provided through the corresponding field for each cell. In this case, the maximum number of HPNs for each cell may mean the maximum number of HPNs configured for each cell scheduled via multi-cell DCI (in the existing single-cell scheduling DCI-based scheduling). Alternatively, the maximum number of HPNs for each cell may refer to the maximum number of HPNs for each cell to be scheduled via (separately configured) multi-cell DCI.
Embodiment 1: Based on the maximum HPN number configured for each cell scheduled (or schedulable) through multi-cell DCI, the HPN field value of each cell may be separately configured. To reduce the size of the DCI, the HPN field size corresponding to each cell may be adjusted to a specific value. In this case, the specific value may be the minimum or maximum of the (maximum) HPN number configured for each cell.
Embodiment 2: The HPN field may be configured based on the minimum value (=N_min) from among the (maximum) HPN numbers configured for each cell scheduled (or schedulable) through multi-cell DCI. For example, the (maximum) number of HPNs to be instructed for each cell (or for PDSCH or PUSCH of each cell) may be a value less than or equal to N_min (or 2^{L} when the HPN field is configured with L=ceil {log₂ (N_min)} bits).
Embodiment 3: The HPN field may be configured based on the maximum value (=N_max) from among the (maximum) HPN numbers configured for each cell scheduled (or schedulable) through multi-cell DCI. For example, the (maximum) number of HPNs to be instructed for each cell (or for the PDSCH or PUSCH of each cell) may be applied modulo the corresponding N_max (or a specific value configured separately based on N_max).
A DCI field size when the separation method is applied may also be determined by the following method.
For reference, for a specific DCI field in the existing single-cell DCI, the size of the corresponding DCI field may be configured to L=ceil {log 2(N)} bits (in a state in which N states/indexes are to be indicated through the corresponding DCI field), and in this case, L may be configured to a different (or the same) value for each cell.
When the HPN field (or RV field) in the multi-cell DCI is configured based on the separation method, first, for each of a plurality of (for example, N_co) co-scheduled cell sets configured in the schedulable cell set, the sum L_sum of L values configured for each of the cells belonging to the corresponding co-scheduled cell set may be calculated, and the maximum value of the N_co L_sum values calculated for each of the N_co co-scheduled cell sets may be determined as a size of the HPN field (configured in the multi-cell DCI).
For example, it is assumed that the entire schedulable cell set includes 4 cells ({cell #1, cell #2, cell #3, and cell #4)}, and L values configured for each cell (i.e., configured for cell #1/2/3/4 respectively) are 1, 2, 4, and 4, respectively. For (cell #1, cell #2, and cell #3) from among the co-scheduled cell sets (combinations) to be simultaneously scheduled via multi-cell DCI, L_sum=7, and for {cell #3 and cell #4}, L_sum=8. For convenience of explanation, it is assumed that only these two sets of co-scheduled cells are schedulable. In this case, the corresponding HPN field size may be determined as 8.
In this case, the “L value configured for each” may mean the (maximum) HPN number defined or configured (separately) for each co-scheduled cell. In other words, the “L value configured for each” means a separate (configured) value for PDSCH/PUSCH scheduled via multi-cell DCI. The corresponding “L value configured for each” may be configured to be equal to or less than/less than the maximum value of the number of HPNs to be conventionally configured for each cell (i.e., HPNs for PDSCH/PUSCH via single-cell DCI). For example, the “L value configured for each” may be defined/configured to any value from 0 bit to 5 bit (similar to DCI format 0_2 or 1_2 used for conventional single-cell DCI).
When there is no separate configuration (for multi-cell DCI), the “L value configured for each” may be the (maximum) HPN number for single-cell DCI to be defined/configured for each cell (or pre-defined/configured). The (maximum) number of HPNs for each cell for single-cell DCI may vary depending on the DCI format. For example, DC format 0_0 or 1_0 may have an HPN number of 4 bits, DC format 0_1 or 1_1 may have an HPN number of 4 bits (or 5 bits), and DCI format 0_2 or 1_2 may have an HPN number of 0 to 5 bits. The “L value configured for each” may be a value corresponding to one of the DCI formats (e.g., 0 to 5 bits may be configured like DCI format 0_2 or 1_2).

### 1.3-2 Opt 2: Application of Separate-Delta Method

A separate HPN field may be configured for each cell scheduled via multi-cell DCI. In a state in which an HPN field (size) (K=ceil{log₂(M)} or 4 bits) is configured according to the maximum number of HPNs M configured for the corresponding cell for a specific reference cell (or PDSCH or PUSCH on the ref. cell) (from among cells scheduled via multi-cell DCI), one HPN value of one of the M HPNs is indicated through the corresponding field. For the remaining cells other than the reference cell (or the PDSCH or PUSCH on the corresponding remaining cells), only an offset value based on the (reference) HPN value indicated to the reference cell may be indicated. An HPN value corresponding to a value obtained by adding the corresponding offset value to the corresponding reference HPN value may be indicated to the PDSCH/PUSCH on the (remaining) cell. For a specific (remaining) cell, when the HPN value (=ref-HPN+offset) determined by adding an offset value to the above reference HPN (ref-HPN) value exceeds the M value configured for the cell, the result of performing a modulo-M operation on the {ref-HPN+offset} value may be determined as the HPN value indicated for the cell, or the maximum value from among the HPN values configured for the cell may be determined as the HPN value indicated for the cell.
Candidate values to be indicated by the offset value may include only of + values including 0, only of − values including 0, or a combination of + values (including 0) and − values.
When the maximum HPN number configured for each cell is different, the HPN field (for cells scheduled via multi-cell DCI) may be configured based on the maximum/minimum value from among the maximum HPN numbers for each cell.
Embodiment 1: (From among cells scheduled through multi-cell DCI) a cell configured to the minimum HPN number is determined as a reference cell, and the reference HPN value is indicated. For PDSCH (or PUSCH) on the remaining cells, only the offset value relative to the corresponding reference HPN value may be indicated. In this case, the offset value (delta value) may be calculated in a wrap-around manner.
Embodiment 2: (From among cells scheduled through multi-cell DCI) a cell with the maximum HPN number is determined/configured as a reference cell. For PDSCH (or PUSCH) on the remaining cells, only the offset value relative to the corresponding minimum HPN value may be configured. In this case, the corresponding offset value (delta value) may be calculated in a wrap-around manner.
Embodiment 3: (From among cells scheduled through multi-cell DCI) a cell with the maximum (or minimum) HPN number is determined/configured as a reference cell. For PDSCH (or PUSCH) on the remaining cells, the HPN field may be configured based on N_max (i.e., the maximum value from among the maximum HPN values configured for each cell scheduled via multi-cell DCI). For example, the HPN value for each cell (or for the PDSCH or PUSCH of each cell) may be a value obtained by modulo N_max by adding the delta value indicated for each cell to the HPN value of the reference cell.
A cell group for configuring/instructing HPN fields/information based on the separate-delta method may be preconfigured. Accordingly, HPN fields/information according to the proposal (based on a reference HPN value indicated to a specific reference cell in the cell group and an offset value indicated to the remaining cells) may be configured/indicated for each cell group scheduled through multi-cell DCI.

### 1.3-3 Opt 3: Application of Shared-Cell-Common

A value indicated by the corresponding HPN field may be commonly applied to the PDSCH (or PUSCH) on all cells (scheduled via multi-cell DCI). Depending on this value, a specific HPN value may be applied equally to PDSCH (or PUSCH) on all cells. When the maximum HPN number configured for each cell is different, the HPN field (for cells scheduled via multi-cell DCI) may be configured based on the maximum/minimum values of the maximum HPN for each cell or the maximum HPN value configured in the reference cell.
In detail, (for cells scheduled through the same multi-cell DCI, belonging to each co-scheduled cell set, belonging to each cell subgroup (within the co-scheduled cell set) or belonging to the entire schedulable cell set), one HPN field (size) commonly applied to the cells (having K=ceil {log₂ (N_max)} bits) may be configured based on the maximum value (N_max) of the maximum HPN numbers (M) configured for each cell, and when the HPN value (A) indicated by the field exceeds the M value or the maximum HPN value (H_max) configured for a specific cell, the result of performing a modulo-M operation on the corresponding A value may be determined as the HPN value indicated for the corresponding cell, the maximum value (or minimum value or a specific value designated by RRC) from among the HPN values configured for the corresponding cell may be determined as the HPN value indicated for the corresponding cell, or considering/assuming that there is no scheduling for the corresponding cell, the cell may operate to perform PDSCH/PUSCH transmission and reception.
Alternatively, a single HPN field (size) commonly applied to the corresponding cells (having L=ceil {log₂ (N_min)} bits) may be configured based on the minimum value (N_min) of the maximum HPN number (M) configured for each cell (for cells scheduled through the same multi-cell DCI, cells belonging to each co-scheduled cell set, cells belonging to each cell subgroup within the co-scheduled cell set, or cells belonging to the entire schedulable cell set). When the HPN value (B) indicated by the corresponding HPN field exceeds the M value or the maximum HPN value (H_max) configured for a specific cell, the result of performing a modulo-M operation on the corresponding B value may be determined as the HPN value indicated for the corresponding cell, the maximum value (or minimum value or a specific value designated by RRC) from among the HPN values configured for the corresponding cell may be determined as the HPN value indicated for the corresponding cell, or PDSCH/PUSCH transmission and reception may be performed considering/assuming that there is no scheduling for the corresponding cell. Alternatively, in this case, only the HPN numbers/values corresponding to N_min (configured in common for the cells) may be indicated through the HPN field. That is, the HPN field may be restricted to indicate only values less than N_min.
Alternatively, a single HPN field (size) commonly applied to the corresponding cells (having R=ceil {log₂ (N_ref)} bits) may be configured based on the maximum HPN value (N_ref) configured for a specific reference cell (from among cells scheduled through the same multi-cell DCI, cells belonging to each co-scheduled cell set, cells belonging to each cell subgroup within the co-scheduled cell set, or cells belonging to the entire schedulable cell set). When the HPN value (C) indicated by the corresponding field exceeds the M value or the maximum HPN value (H_max) configured for a specific cell, the result of performing a modulo-M operation on the corresponding C value may be determined as the HPN value indicated for the corresponding cell, the maximum value (or minimum value or a specific value designated by RRC) from among the HPN values configured for the corresponding cell may be determined as the HPN value indicated for the corresponding cell, or PDSCH/PUSCH transmission and reception may be performed considering/assuming that there is no scheduling for the corresponding cell. In this case, only the HPN numbers/values corresponding to N_ref may be indicated through the corresponding field. That is, only values less than N_ref may be indicated for the corresponding field.

A cell group for commonly applying one (shared) HPN field may be preconfigured based on the shared-cell-common method. Accordingly, shared HPN fields/information according to the proposal may be configured/indicated for each cell group scheduled through multi-cell DCI.

When the maximum HPN number configured for each cell belonging to the cell group is different, HPN information to be commonly applied to all cells in the cell group may be configured/indicated based on the maximum HPN number configured for a (specific) reference cell (by determining the HPN field size). In this case, the reference cell may be a cell configured with a maximum/minimum HPN number, a cell corresponding to the lowest cell index, a scheduling cell, or a cell separately designated by RRC.

The contents of the present disclosure are not limitedly applied only to UL and/or DL signal transmission and reception. For example, the contents of the present disclosure may also be used for direct communication between UEs. In this document, the term based station (BS) may be understood as a concept including a relay node as well as a BS. For example, the operations of a BS described in the present disclosure may be performed by a relay node as well as the BS.

It is obvious that each of the examples of the proposed methods may also be included as one implementation method of the present disclosure, and thus each example may be regarded as a kind of proposed method. Although the above-described proposed methods may be implemented independently, some of the proposed methods may be combined and implemented. In addition, it may be regulated that information on whether the proposed methods are applied (or information on rules related to the proposed methods) is transmitted from the BS to the UE in a predefined signal (e.g., physical layer signaling or higher layer signaling).

### Implementation Examples

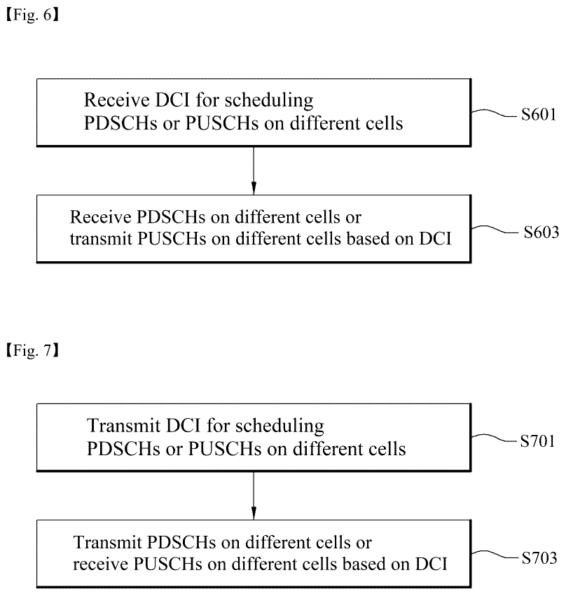

FIGS. 6 and 7 are flowcharts of a signal transmission and reception method according to an embodiment of the present disclosure.

Referring to FIG. 6, the method according to an embodiment of the present disclosure may be performed by a UE and may include receiving DCI for scheduling PDSCHs or PUSCHs on different cells (S601) and receiving the PDSCHs on the different cells or transmitting the PUSCHs on the different cells based on the DCI (S603).

Referring to FIG. 7, the method according to another embodiment of the present disclosure may be performed by a BS and may include transmitting DCI for scheduling PDSCHs or PUSCHs on different cells (S701) and transmitting the PDSCHs on the different cells or receiving the PUSCHs on the different cells based on the DCI (S703).

In addition to the operations of FIGS. 6 and/or 7, one or more of the operations described through Section 1 may be additionally performed.

In detail, referring to Sections 1.1 to 1.3, DCI for scheduling the PDSCHs or PUSCHs on different cells may be referred to as multi-cell DCI. The multi-cell DCI includes one or more NDI fields, one or more RV fields, and/or one or more HPN fields for PDSCHs or PUSCHs on different cells. In the multi-cell DCI structure, the NDI field may include a combination of one or more of the structures proposed in Section 1.1. The RV field may include a combination of one or more of the structures proposed in Section 1.2. The HPN field may include a combination of one or more of the structures proposed in Section 1.3.

According to 1.2-1 Opt 1 of Section 1.2, the separate-equal method is applied to the RV field. Therefore, the DCI includes RV fields with the same number as the number of PDSCHs or the number of PUSCHs. According to 1.3-1 Opt 1 of Section 1.3, the Separate-equal method or the separation method is applied to the HPN field. Therefore, the DCI includes HPN fields with the same number as the number of PDSCHs or the number of PUSCHs.

Here, according to the embodiment 1 of 1.2-1 Opt 1, the size of each RV field is configured with 1 bit per TB. Therefore, a 2-bit RV field is configured for cells configured to allow up to 2 TB transmission on a PDSCH or a PUSCH. A 1-bit RV field is configured for cells configured to allow only 1 TB transmission on a PDSCH or a PUSCH.

According to embodiment 2 of 1.2-1 Opt 1, a first RV field of 1 bit per TB is configured for a cell configured to allow up to 2 TB transmission on a PDSCH or a PUSCH. A second RV field of 2 bits per TB is configured for cells configured to allow only 1 TB transmission on a PDSCH or a PUSCH.

According to embodiment 3 of 1.2-1 Opt 1, when a PDSCH or a PUSCH is scheduled only for a single cell through multi-cell DCI, a 2-bit RV field per TB is configured for the corresponding single cell. When PDSCHs or PUSCHs are scheduled to multiple cells via multi-cell DCI, a 1-bit RV field per TB is configured for each cell.

According to Section 1.2, when the separation method is applied, an RV field size may be configured to the largest value from among L-sums, which are the sums of L values for each of a plurality of co-scheduled cell sets configured in the schedulable cell set. In other words, when an RV field corresponding to one cell in DCI is called one RV field, the number of bits of all RV fields provided in the DCI is configured as the maximum value from among the sums of the number of bits of the RV fields calculated for each combination of all or some of the different cells to be scheduled by the DCI.

The L value for each cell may be configured separately with respect to multi-cell DCI. Without a separate configuration, the L value for each cell may be the number of bits in the RV field related to a single-cell DCI in the corresponding cell. Therefore, when the sum of the bit numbers of RV fields is calculated for each combination of all or some of the different cells, the sum calculated for a specific combination may be the sum of the bit numbers of RV fields for a single cell-DCI for the cells belonging to the specific combination.

According to 1.3-1 Opt 1 of Section 1.3, the separate-equal method or the separation method is applied to the HPN field. According to the separate-equal method, the number of bits in the HPN field for each cell is configured equally. Here, the number of bits in a single HPN field may be determined according to the number of cells scheduled by DCI.

According to Section 1.3, when the separation method is applied, an HPN field size may be configured to the largest value from among L-sums, which are the sums of L values for each of a plurality of co-scheduled cell sets configured in the schedulable cell set, like the RV field size. In other words, when an HPN field corresponding to one cell in DCI is called one HPN field, the number of bits of all HPN fields provided in the DCI is configured as the maximum value from among the sums of the number of bits of the HPN fields calculated for each combination of all or some of the different cells to be scheduled by the DCI.

The L value for each cell may be configured separately with respect to multi-cell DCI. Without a separate configuration, the L value for each cell may be the number of bits in the HPN field related to a single-cell DCI in the corresponding cell. Therefore, when the sum of the bit numbers of HPN fields is calculated for each combination of all or some of the different cells, the sum calculated for a specific combination may be the sum of the bit numbers of HPN fields for a single cell-DCI for the cells belonging to the specific combination.

In addition to the operations described with respect to FIGS. 6 and 7, one or more of the operations described with respect to FIGS. 1 to 5 and/or the operations described in Section 1 may be additionally performed in combination.

Example of Communication System to which the Present Disclosure is Applied

The various descriptions, functions, procedures, proposals, methods, and/or operation flowcharts of the present disclosure described herein may be applied to, but not limited to, various fields requiring wireless communication/connectivity (e.g., 5G) between devices.

More specific examples will be described below with reference to the drawings. In the following drawings/description, like reference numerals denote the same or corresponding hardware blocks, software blocks, or function blocks, unless otherwise specified.

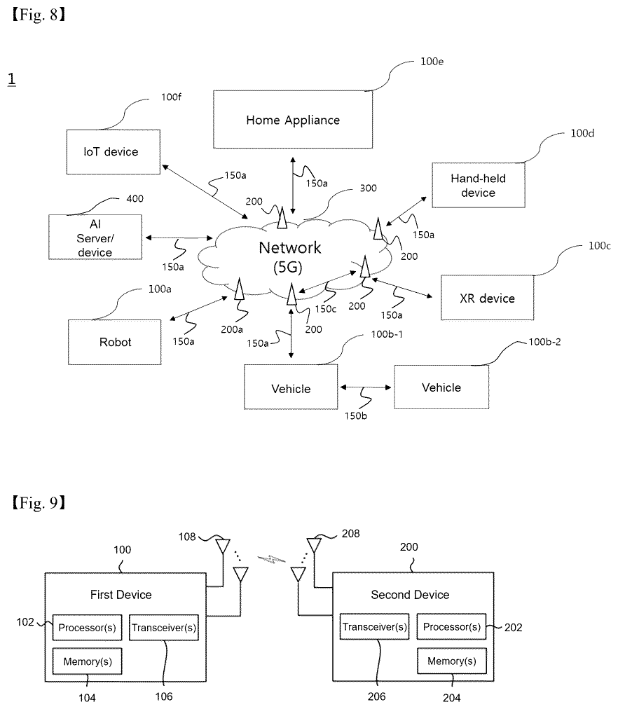

FIG. 8 illustrates a communication system 1 applied to the present disclosure.

Referring to FIG. 8, the communication system 1 applied to the present disclosure includes wireless devices, BSs, and a network. A wireless device is a device performing communication using radio access technology (RAT) (e.g., 5G NR (or New RAT) or LTE), also referred to as a communication/radio/5G device. The wireless devices may include, not limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of vehicle-to-vehicle (V2V) communication. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television (TV), a smartphone, a computer, a wearable device, a home appliance, a digital signage, a vehicle, a robot, and so on. The hand-held device may include a smartphone, a smart pad, a wearable device (e.g., a smart watch or smart glasses), and a computer (e.g., a laptop). The home appliance may include a TV, a refrigerator, a washing machine, and so on. The IoT device may include a sensor, a smart meter, and so on. For example, the BSs and the network may be implemented as wireless devices, and a specific wireless device 200a may operate as a BS/network node for other wireless devices.

The wireless devices 100a to 100f may be connected to the network 300 via the BSs 200. An AI technology may be applied to the wireless devices 100a to 100f, and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without intervention of the BSs/network. For example, the vehicles 100b-1 and 100b-2 may perform direct communication (e.g., V2V/vehicle-to-everything (V2X) communication). The IoT device (e.g., a sensor) may perform direct communication with other IoT devices (e.g., sensors) or other wireless devices 100a to 100f.

Wireless communication/connections 150a, 150b, and 150c may be established between the wireless devices 100a to 100f/BS 200 and between the BSs 200. Herein, the wireless communication/connections may be established through various RATs (e.g., 5G NR) such as UL/DL communication 150a, sidelink communication 150b (or, D2D communication), or inter-BS communication (e.g., relay or integrated access backhaul (IAB)). Wireless signals may be transmitted and received between the wireless devices, between the wireless devices and the BSs, and between the BSs through the wireless communication/connections 150a, 150b, and 150c. For example, signals may be transmitted and receive don various physical channels through the wireless communication/connections 150a, 150b and 150c. To this end, at least a part of various configuration information configuring processes, various signal processing processes (e.g., channel encoding/decoding, modulation/demodulation, and resource mapping/demapping), and resource allocation processes, for transmitting/receiving wireless signals, may be performed based on the various proposals of the present disclosure.

Example of Wireless Device to which the Present Disclosure is Applied

FIG. 9 illustrates wireless devices applicable to the present disclosure.

Referring to FIG. 9, a first wireless device 100 and a second wireless device 200 may transmit wireless signals through a variety of RATs (e.g., LTE and NR). {The first wireless device 100 and the second wireless device 200) may correspond to (the wireless device 100x and the BS 200) and/or (the wireless device 100x and the wireless device 100x} of FIG. 8.

The first wireless device 100 may include one or more processors 102 and one or more memories 104, and further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operation flowcharts disclosed in this document. For example, the processor(s) 102 may process information in the memory(s) 104 to generate first information/signals and then transmit wireless signals including the first information/signals through the transceiver(s) 106. The processor(s) 102 may receive wireless signals including second information/signals through the transceiver(s) 106 and then store information obtained by processing the second information/signals in the memory(s) 104. The memory(s) 104 may be connected to the processor(s) 102 and may store various pieces of information related to operations of the processor(s) 102. For example, the memory(s) 104 may store software code including instructions for performing all or a part of processes controlled by the processor(s) 102 or for performing the descriptions, functions, procedures, proposals, methods, and/or operation flowcharts disclosed in this document. The processor(s) 102 and the memory(s) 104 may be a part of a communication modem/circuit/chip designed to implement RAT (e.g., LTE or NR). The transceiver(s) 106 may be connected to the processor(s) 102 and transmit and/or receive wireless signals through the one or more antennas 108. Each of the transceiver(s) 106 may include a transmitter and/or a receiver. The transceiver(s) 106 may be interchangeably used with radio frequency (RF) unit(s). In the present disclosure, the wireless device may be a communication modem/circuit/chip.

The second wireless device 200 may include one or more processors 202 and one or more memories 204, and further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operation flowcharts disclosed in this document. For example, the processor(s) 202 may process information in the memory(s) 204 to generate third information/signals and then transmit wireless signals including the third information/signals through the transceiver(s) 206. The processor(s) 202 may receive wireless signals including fourth information/signals through the transceiver(s) 106 and then store information obtained by processing the fourth information/signals in the memory(s) 204. The memory(s) 204 may be connected to the processor(s) 202 and store various pieces of information related to operations of the processor(s) 202. For example, the memory(s) 204 may store software code including instructions for performing all or a part of processes controlled by the processor(s) 202 or for performing the descriptions, functions, procedures, proposals, methods, and/or operation flowcharts disclosed in this document. The processor(s) 202 and the memory(s) 204 may be a part of a communication modem/circuit/chip designed to implement RAT (e.g., LTE or NR). The transceiver(s) 206 may be connected to the processor(s) 202 and transmit and/or receive wireless signals through the one or more antennas 208. Each of the transceiver(s) 206 may include a transmitter and/or a receiver. The transceiver(s) 206 may be interchangeably used with RF unit(s). In the present disclosure, the wireless device may be a communication modem/circuit/chip.

Now, hardware elements of the wireless devices 100 and 200 will be described in greater detail. One or more protocol layers may be implemented by, not limited to, one or more processors 102 and 202. For example, the one or more processors 102 and 202 may implement one or more layers (e.g., functional layers such as physical (PHY), medium access control (MAC), radio link control (RLC), packet data convergence protocol (PDCP), RRC, and service data adaptation protocol (SDAP)). The one or more processors 102 and 202 may generate one or more protocol data units (PDUs) and/or one or more service data Units (SDUs) according to the descriptions, functions, procedures, proposals, methods, and/or operation flowcharts disclosed in this document. The one or more processors 102 and 202 may generate messages, control information, data, or information according to the descriptions, functions, procedures, proposals, methods, and/or operation flowcharts disclosed in this document and provide the messages, control information, data, or information to one or more transceivers 106 and 206. The one or more processors 102 and 202 may generate signals (e.g., baseband signals) including PDUs, SDUs, messages, control information, data, or information according to the descriptions, functions, procedures, proposals, methods, and/or operation flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operation flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. For example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operation flowcharts disclosed in this document may be implemented using firmware or software, and the firmware or software may be configured to include the modules, procedures, or functions. Firmware or software configured to perform the descriptions, functions, procedures, proposals, methods, and/or operation flowcharts disclosed in this document may be included in the one or more processors 102 and 202 or may be stored in the one or more memories 104 and 204 and executed by the one or more processors 102 and 202. The descriptions, functions, procedures, proposals, methods, and/or operation flowcharts disclosed in this document may be implemented using firmware or software in the form of code, an instruction, and/or a set of instructions.

The one or more memories 104 and 204 may be connected to the one or more processors 102 and 202 and store various types of data, signals, messages, information, programs, code, instructions, and/or commands. The one or more memories 104 and 204 may be configured to include read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or wireless signals/channels, mentioned in the methods and/or operation flowcharts of this document, to one or more other devices. The one or more transceivers 106 and 206 may receive user data, control information, and/or wireless signals/channels, mentioned in the descriptions, functions, procedures, proposals, methods, and/or operation flowcharts disclosed in this document, from one or more other devices. For example, the one or more transceivers 106 and 206 may be connected to the one or more processors 102 and 202 and transmit and receive wireless signals. For example, the one or more processors 102 and 202 may perform control so that the one or more transceivers 106 and 206 may transmit user data, control information, or wireless signals to one or more other devices. The one or more processors 102 and 202 may perform control so that the one or more transceivers 106 and 206 may receive user data, control information, or wireless signals from one or more other devices. The one or more transceivers 106 and 206 may be connected to the one or more antennas 108 and 208 and the one or more transceivers 106 and 206 may be configured to transmit and receive user data, control information, and/or wireless signals/channels, mentioned in the descriptions, functions, procedures, proposals, methods, and/or operation flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received wireless signals/channels from RF band signals into baseband signals in order to process received user data, control information, and wireless signals/channels using the one or more processors 102 and 202. The one or more transceivers 106 and 206 may convert the user data, control information, and wireless signals/channels processed using the one or more processors 102 and 202 from the baseband signals into the RF band signals. To this end, the one or more transceivers 106 and 206 may include (analog) oscillators and/or filters.

Example of Use of Wireless Device to which the Present Disclosure is Applied

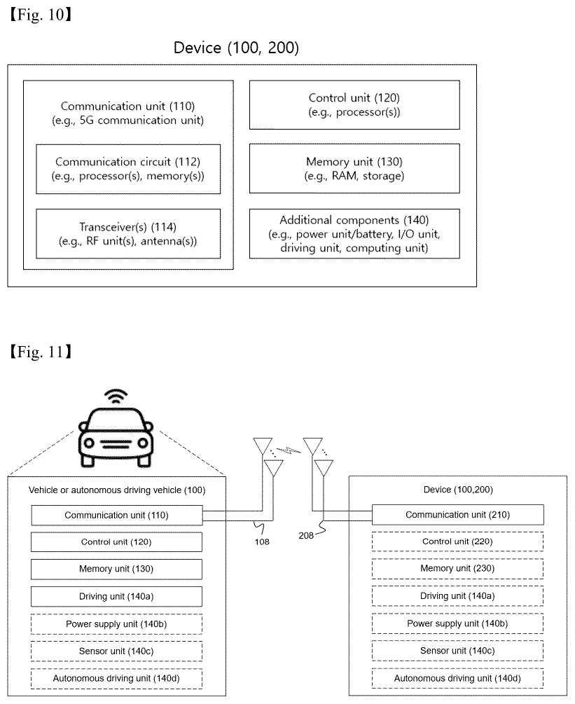

FIG. 10 illustrates another example of a wireless device applied to the present disclosure. The wireless device may be implemented in various forms according to a use case/service (refer to FIG. 8).

Referring to FIG. 10, wireless devices 100 and 200 may correspond to the wireless devices 100 and 200 of FIG. 9 and may be configured to include various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 and/or the one or more memories 104 and 204 of FIG. 9. For example, the transceiver(s) 114 may include the one or more transceivers 106 and 206 and/or the one or more antennas 108 and 208 of FIG. 9. The control unit 120 is electrically connected to the communication unit 110, the memory 130, and the additional components 140 and provides overall control to the wireless device. For example, the control unit 120 may control an electric/mechanical operation of the wireless device based on programs/code/instructions/information stored in the memory unit 130. The control unit 120 may transmit the information stored in the memory unit 130 to the outside (e.g., other communication devices) via the communication unit 110 through a wireless/wired interface or store, in the memory unit 130, information received through the wireless/wired interface from the outside (e.g., other communication devices) via the communication unit 110.

The additional components 140 may be configured in various manners according to type of the wireless device. For example, the additional components 140 may include at least one of a power unit/battery, input/output (I/O) unit, a driving unit, and a computing unit. The wireless device may be implemented in the form of, not limited to, the robot (100a of FIG. 8), the vehicles (100b-1 and 100b-2 of FIG. 8), the XR device (100c of FIG. 8), the hand-held device (100d of FIG. 8), the home appliance (100e of FIG. 8), the IoT device (100f of FIG. 8), a digital broadcasting terminal, a hologram device, a public safety device, an MTC device, a medical device, a FinTech device (or a finance device), a security device, a climate/environment device, the AI server/device (400 of FIG. 8), the BSs (200 of FIG. 8), a network node, or the like. The wireless device may be mobile or fixed according to a use case/service.

In FIG. 10, all of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module in the wireless devices 100 and 200 may further include one or more elements. For example, the control unit 120 may be configured with a set of one or more processors. For example, the control unit 120 may be configured with a set of a communication control processor, an application processor, an electronic control unit (ECU), a graphical processing unit, and a memory control processor. In another example, the memory 130 may be configured with a RAM, a dynamic RAM (DRAM), a ROM, a flash memory, a volatile memory, a non-volatile memory, and/or a combination thereof.

Example of Vehicle or Autonomous Driving Vehicle to which the Present Disclosure is Applied

FIG. 11 illustrates a vehicle or an autonomous driving vehicle applied to the present disclosure. The vehicle or autonomous driving vehicle may be implemented as a mobile robot, a car, a train, a manned/unmanned aerial vehicle (AV), a ship, or the like.

Referring to FIG. 11, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 10, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may enable the vehicle or the autonomous driving vehicle 100 to drive on a road. The driving unit 140a may include an engine, a motor, a powertrain, a wheel, a brake, a steering device, and so on. The power supply unit 140b may supply power to the vehicle or the autonomous driving vehicle 100 and include a wired/wireless charging circuit, a battery, and so on. The sensor unit 140c may acquire information about a vehicle state, ambient environment information, user information, and so on. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, and so on. The autonomous driving unit 140d may implement technology for maintaining a lane on which the vehicle is driving, technology for automatically adjusting speed, such as adaptive cruise control, technology for autonomously driving along a determined path, technology for driving by automatically setting a route if a destination is set, and the like.

For example, the communication unit 110 may receive map data, traffic information data, and so on from an external server. The autonomous driving unit 140d may generate an autonomous driving route and a driving plan from the obtained data. The control unit 120 may control the driving unit 140a such that the vehicle or autonomous driving vehicle 100 may move along the autonomous driving route according to the driving plan (e.g., speed/direction control). During autonomous driving, the communication unit 110 may aperiodically/periodically acquire recent traffic information data from the external server and acquire surrounding traffic information data from neighboring vehicles. During autonomous driving, the sensor unit 140c may obtain information about a vehicle state and/or surrounding environment information. The autonomous driving unit 140d may update the autonomous driving route and the driving plan based on the newly obtained data/information. The communication unit 110 may transfer information about a vehicle position, the autonomous driving route, and/or the driving plan to the external server. The external server may predict traffic information data using AI technology based on the information collected from vehicles or autonomous driving vehicles and provide the predicted traffic information data to the vehicles or the autonomous driving vehicles.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

As described above, the present disclosure is applicable to various wireless communication systems.

1. A method of transmitting and receiving a signal by a user equipment (UE) in a wireless communication system, the method comprising:
receiving downlink control information (DCI) for scheduling physical downlink shared channels (PDSCHs) or physical uplink shared channels (PUSCHs) on different cells; and
receiving the PDSCHs on the different cells or transmitting the PUSCHs on the different cells based on the DCI,
wherein the DCI includes a number of redundancy version (RV) fields, equal to a number of the PDSCHs or a number of the PUSCHs, and
the DCI includes a number of hybrid automatic repeat and request acknowledgement process number (HPN) fields, equal to the number of the PDSCHs or the number of the PUSCHs.

2. The method of claim 1, wherein each of the RV fields is configured with 1 bit per transport block (TB).

3. The method of claim 1, wherein the RV fields include:
a first RB field configured with 1 bit per TB for a PDSCH or a PUSCH configured to transmit two transport blocks (TBs); and
a second RB field configured with 2 bits per TB for a PDSCH or a PUSCH configured to transmit 1 TB.

4. The method of claim 1, wherein each of the RV fields is configured with 2 bits per transport block (TB) based on one PDSCH or PUSCH being scheduled by the DCI and is configured with 1 bit per TB based on a plurality of PDSCHs or PUSCHs being scheduled by the DCI.

5. The method of claim 1, wherein a bit number of all RV fields is configured by a maximum value of sums of bit numbers of RV fields calculated for each combination of all or some of the different cells.

6. The method of claim 5, wherein a bit number of each of the RV fields is determined based on a bit number of an RV field of the DCI for scheduling a single PDSCH or PUSCH within a corresponding single cell.

7. The method of claim 1, wherein bit numbers of the HPN fields are configured equally, and
the bit numbers are determined based on a number of cells in which the PDSCH or the PDSCH is actually scheduled from among the different cells.

8. The method of claim 1, wherein a bit number of all HPN fields is configured by a maximum value of sums of sizes of HPN fields calculated for each combination of all or some of the different cells.

9. The method of claim 8, wherein a bit number of each of the HPN fields is determined based on a bit number of an HPN field of the DCI for scheduling a single PDSCH or PUSCH within a corresponding single cell.

10. A user equipment (UE) for transmitting and receiving a signal in a wireless communication system, the UE comprising:
at least one transceiver;
at least one processor; and
at least one computer memory operatively connected to the at least one processor and configured to store instructions that when executed cause the at least one processor to perform a specific operation including:
receiving downlink control information (DCI) for scheduling physical downlink shared channels (PDSCHs) or physical uplink shared channels (PUSCHs) on different cells; and
receiving the PDSCHs on the different cells or transmitting the PUSCHs on the different cells based on the DCI,
wherein the DCI includes a number of redundancy version (RV) fields, equal to a number of transport blocks (TBs) of the PDSCHs or a number of TBs of the PUSCHs, and
the DCI includes a number of hybrid automatic repeat and request acknowledgement process number (HPN) fields, equal to a number of the PDSCHs or a number of the PUSCHs.

11-13. (canceled)

14. A base station (BS) for monitoring a control signal in a wireless communication system, the BS comprising:
at least one transceiver;
at least one processor; and
at least one computer memory operatively connected to the at least one processor and configured to store instructions that when executed cause the at least one processor to perform a specific operation including:
transmitting downlink control information (DCI) for scheduling physical downlink shared channels (PDSCHs) or physical uplink shared channels (PUSCHs) on different cells; and
transmitting the PDSCHs on the different cells or receiving the PUSCHs on the different cells based on the DCI,
wherein the DCI includes a number of redundancy version (RV) fields, equal to a number of transport blocks (TBs) of the PDSCHs or a number of TBs of the PUSCHs, and
the DCI includes a number of hybrid automatic repeat and request acknowledgement process number (HPN) fields, equal to a number of the PDSCHs or a number of the PUSCHs.
